(19) United States
(12) Patent Application Publication
(10) Pub. No.: US 2026/0135396 A1
(43) Pub. Date: May 14, 2026

(54) Discharge Device For DC Bus Capacitor

(71) Applicant: Siemens Aktiengesellschaft, München (DE)

(72) Inventors: Qing Li Huang, Nanjing (CN); Peng Cheng Li, Shenzhen (CN); Xiao Long Chen, Nanjing (CN); Yan Hua Lu, Nanjing (CN); Yu Xu, Nanjing (CN)

(73) Assignee: Siemens Aktiengesellschaft, München (DE)

(21) Appl. No.: 19/121,331

(22) PCT Filed: Oct. 18, 2022
(86) PCT No.: PCT/CN2022/125911

§ 371 Date: Apr. 15, 2025

(51) Int. Cl. H02J 7/34; H02M 3/155

(52) U.S. Cl. CPC H02J 7/345; H02M 3/155; H02J 2207/50

(57) ABSTRACT

Various embodiments of the teachings herein include a discharge device for a DC bus capacitor. An example device includes: a resistor connected in series with a DC bus capacitor of a converter; a braking IGBT connected between a positive electrode and a negative electrode of the DC bus capacitor; a switch connected to the braking IGBT and the resistor; and a control unit to turn on the braking IGBT in response to a power supply system of the converter being powered off, and control a state of the switch to discharge the DC bus capacitor, using the resistor and the braking IGBT.

### CROSS-REFERENCE TO RELATED APPLICATIONS

This application is a U.S. National Stage Application of International Application No. PCT/CN2022/125911 filed Oct. 18, 2022, which designates the United States of America, the contents of which are hereby incorporated by reference in their entirety.

### TECHNICAL FIELD

The present disclosure relates to electrical technology. Various embodiments include discharge devices for DC bus capacitor and methods of operating discharge devices.

### BACKGROUND

A power electronic converter is an electrical device that changes the voltage, frequency, number of phases, and other quantities or characteristics of a power supply system. DC (Direct Current) bus capacitor of the converter may be composed of one or more capacitors in series. To ensure that shared voltage of each capacitor in series is the same, each capacitor is usually connected in parallel with a voltage sharing resistor. On the premise of meeting requirements of voltage sharing, the resistance value of voltage sharing resistance is usually large to ensure that it does not consume too much energy.

In the prior art, when converter is shut down, DC bus capacitor is discharged through the voltage sharing resistors. However, due to large resistance of the voltage sharing resistors, discharge time is long (for example, 5 minutes).

### SUMMARY

Teachings of the present disclosure include converters, control methods therefor, electrical devices, and readable storage media. For example, some embodiments include a discharge device for a DC bus capacitor, comprising: a resistor (11), connected in series with a DC bus capacitor (12) of a converter; a braking IGBT (13), connected between a positive electrode (DCP) and a negative electrode (DCN) of the DC bus capacitor (12); a switch (14), which is respectively connected to the braking IGBT (13) and the resistor (11); and a control unit (15), configured to turn on the braking IGBT (13) when detecting that a power supply system (16) of the converter is powered off, and control a state of the switch (14) to conduct a discharging circuit of the DC bus capacitor (12), the discharging circuit comprising the resistor (11) and the braking IGBT (13).

In some embodiments, the control unit (15) is configured to turn off the braking IGBT (13) when detecting that the DC bus capacitor (12) is in a charging state, and control a state of the switch (14) to conduct a charging circuit of the DC bus capacitor (12), the charging circuit comprising the resistor (11) and a rectifier module (17) of the converter.

In some embodiments, the control unit (15) is configured to control a state of the switch (14) to short-circuit the resistor (11) when detecting that the converter (12) is in a normal working state.

In some embodiments, the switch (14) comprising a single pole double throw switch, the single pole double throw switch comprising a first static contact (21), a second static contact (22) and a moving contact (23), the first static contact (21) is connected between a first terminal of the resistor (11) and the DC bus capacitor (12), the second static contact (22) is connected with the braking IGBT (13), and the moving contact (23) is connected with a second terminal of the resistor (11).

In some embodiments, the braking IGBT (13) comprising a grid, a collector, and an emitter, wherein the grid is connected with the control unit (15), the collector is connected with the positive electrode (DCP) of the DC bus capacitor (12) via a diode (18), and the emitter is connected with the negative electrode (DCN) of the DC bus capacitor (12).

As another example, some embodiments include a method for discharging a DC bus capacitor of a converter, the converter comprising: a resistor connected in series with the DC bus capacitor of the converter; a braking IGBT connected between a positive electrode (DCP) and a negative electrode (DCN) of the DC bus capacitor; a switch, which is respectively connected to the braking IGBT and the resistor; the method comprising: detecting an electrical connection state between the converter and a power supply system of the converter (501); turning on the braking IGBT when the electrical connection state indicates that the power supply system is powered off (502); and controlling a state of the switch to conduct a discharging circuit of the DC bus capacitor, the discharging circuit comprising the resistor and the braking IGBT (503).

In some embodiments, the method further comprises: turning off the braking IGBT when detecting that the DC bus capacitor is in a charging state; and controlling a state of the switch to conduct a charging circuit of the DC bus capacitor, the charging circuit comprising the resistor and a rectifier module of the converter.

In some embodiments, the method according to claim 6, further comprises controlling a state of the switch to short-circuit the resistor when detecting that the converter is in a normal working state.

In some embodiments, the switch comprising a single pole double throw switch, the single pole double throw switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling the state of the switch to conduct the discharging circuit of the DC bus capacitor comprising: controlling the moving contact to be in electrical contact with the second static contact.

In some embodiments, the switch comprising a single pole double throw switch, the single pole double throw switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling a state of the switch to conduct a charging circuit of the DC bus capacitor comprising: controlling the moving contact to be in electrical contact with the second static contact.

In some embodiments, the switch comprising a single pole double throw switch, the single pole double throw switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling a state of the switch to short-circuit the resistor comprising: controlling the moving contact to be in electrical contact with the first static contact.

As another example, some embodiments include an electrical device, comprising a processor (601) and a memory (602), wherein an application program executable by the processor (601) is stored in the memory (602) for causing the processor (601) to execute one or more of the methods for discharging a DC bus capacitor of a converter as described herein.

As another example, some embodiments include a computer-readable medium comprising computer-readable instructions stored thereon, wherein the computer-readable instructions for executing one or more of the methods for discharging a DC bus capacitor of a converter as described herein.

As another example, some embodiments include a computer program product comprising a computer program, upon the computer program is executed by a processor for executing one or more of the methods for discharging a DC bus capacitor of a converter as described herein.

### BRIEF DESCRIPTION OF THE DRAWINGS

In order to make technical solutions of examples of the present disclosure clearer, accompanying drawings to be used in description of the examples will be simply introduced hereinafter. Obviously, the accompanying drawings to be described hereinafter are only some examples of the present disclosure. Those skilled in the art may obtain other drawings according to these accompanying drawings without creative labor. In the drawings:

FIG. 1 is a structural diagram of an example discharging device for DC bus capacitor of a converter incorporating teachings of the present disclosure;

FIG. 2 is a schematic diagram of a discharging state of an example DC bus capacitor incorporating teachings of the present disclosure;

FIG. 3 is a schematic diagram of a charging state of an example DC bus capacitor incorporating teachings of the present disclosure;

FIG. 4 is a schematic diagram of a normal working state of an example converter incorporating teachings of the present disclosure;

FIG. 5 is a flowchart of an example discharging method for a DC bus capacitor of a converter incorporating teachings of the present disclosure; and

FIG. 6 is a structural diagram of an example electrical device incorporating teachings of the present disclosure.

List of reference numbers:

| reference numbers | meanings |
|---|---|
| 11 | resistor |
| 12 | DC bus capacitor |
| 13 | braking IGBT |
| 14 | switch |
| 15 | control unit |
| 16 | power supply system |
| 17 | rectifier module |
| 18 | diode |
| 21 | first static contact |
| 22 | second static contact |
| 23 | moving contact |
| 501~503 | steps |
| 600 | electrical device |
| 601 | processor |
| 602 | memory |

### DETAILED DESCRIPTION

Some embodiments of the teachings herein include discharge devices for a DC bus capacitor. An example device comprises: a resistor, connected in series with a DC bus capacitor of a converter; a braking IGBT, connected between a positive electrode (DCP) and a negative electrode (DCN) of the DC bus capacitor; a switch, which is respectively connected to the braking IGBT and the resistor; and a control unit, configured to turn on the braking IGBT when detecting that a power supply system of the converter is powered off, and control a state of the switch to conduct a discharging circuit of the DC bus capacitor, the discharging circuit comprising the resistor and the braking IGBT. Therefore, when it is detected that power supply system of the converter is powered off, the braking IGBT is reused to realize rapid discharge of DC bus capacitor, thus reducing discharge time.

In some embodiments, the control unit is configured to turn off the braking IGBT when detecting that the DC bus capacitor is in a charging state, and control a state of the switch to conduct a charging circuit of the DC bus capacitor, the charging circuit comprising the resistor and a rectifier module of the converter. Therefore, when it is detected that the DC bus capacitor is in a charging state, turn off the braking IGBT, and introduce the resistor in series with the DC bus capacitor into the charging circuit. The resistor can limit instantaneous charging current, thus protecting components such as rectifier modules.

In some embodiments, the control unit is configured to control a state of the switch to short-circuit the resistor when detecting that the converter is in a normal working state. Therefore, when the converter works normally, the resistor is shorted to save energy.

In some embodiments, the switch comprising a SPDT (single pole double throw) switch, the SPDT switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor. Therefore, through the coordinated control of SPDT switch and braking IGBT, flexible switching between charging state, normal working state and discharging state can be realized.

In some embodiments, the braking IGBT comprising a grid, a collector, and an emitter, wherein the grid is connected with the control unit, the collector is connected with DCP of the DC bus capacitor via a diode, and the emitter is connected with DCN of the DC bus capacitor. Therefore, the braking IGBT can be easily reused through the control unit.

Some embodiments include a method for discharging a DC bus capacitor of a converter, the converter comprising: a resistor connected in series with the DC bus capacitor of the converter; a braking IGBT connected between DCP and DCN of the DC bus capacitor; a switch, which is respectively connected to the braking IGBT and the resistor. The method comprising: detecting an electrical connection state between the converter and a power supply system of the converter; turning on the braking IGBT when the electrical connection state indicates that the power supply system is powered off; and controlling a state of the switch to conduct a discharging circuit of the DC bus capacitor, the discharging circuit comprising the resistor and the braking IGBT. Therefore, when it is detected that the power supply system of the converter is powered off, the braking IGBT is reused to realize rapid discharge of the DC bus capacitor, thus reducing the discharge time

In some embodiments, the method further comprises: turning off the braking IGBT when detecting that the DC bus capacitor is in a charging state; and controlling a state of the switch to conduct a charging circuit of the DC bus capacitor, the charging circuit comprising the resistor and a rectifier module of the converter. Therefore, when it is detected that the DC bus capacitor is in charging state, close the braking IGBT, and introduce the resistor in series with the DC bus capacitor into the charging circuit. The resistor can limit instantaneous charging current, thus protecting components such as rectifier modules.

In some embodiments, the method further comprises controlling a state of the switch to short-circuit the resistor when detecting that the converter is in a normal working state. Therefore, when the converter works normally, the resistor is shorted to save energy.

In some embodiments, the switch comprising a SPDT switch, the SPDT switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling the state of the switch to conduct the discharging circuit of the DC bus capacitor comprising: controlling the moving contact to be in electrical contact with the second static contact. Therefore, the converter can be flexibly controlled through the coordinated control of SPDT and braking IGBT.

In some embodiments, the switch comprising a SPDT switch, the SPDT switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling a state of the switch to conduct a charging circuit of the DC bus capacitor comprising: controlling the moving contact to be in electrical contact with the second static contact. Therefore, the charging process of DC bus capacitor can be controlled by SPDT switch.

In some embodiments, the switch comprising a SPDT switch, the SPDT switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor; wherein the controlling a state of the switch to short-circuit the resistor comprising: controlling the moving contact to be in electrical contact with the first static contact. Therefore, the resistor can be short-circuited through the SPDT switch to save energy.

Some embodiments include an electrical device comprising a processor and a memory, wherein an application program executable by the processor is stored in the memory for causing the processor to execute one or more of the methods for discharging a DC bus capacitor of a converter described herein.

Some embodiments include a computer-readable medium comprising computer-readable instructions stored thereon is provided, wherein the computer-readable instructions for executing one or more of the methods for discharging a DC bus capacitor of a converter described herein.

Some embodiments include a computer program product comprising a computer program, When the computer program is executed by a processor for executing one or more of the methods for discharging a DC bus capacitor of a converter described herein.

### DETAILED DESCRIPTION

In order to make the purpose, technical scheme, and advantages of the teachings herein more clear, the following examples are given to further explain them in detail. In order to be concise and intuitive in description, the schemes are described below by describing several representative embodiments. Many details in the embodiments are only used to help understand the teachings. However, it is obvious that the technical schemes can be realized without being limited to these details. In order to avoid unnecessarily blurring, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more or can be understood as at least one.

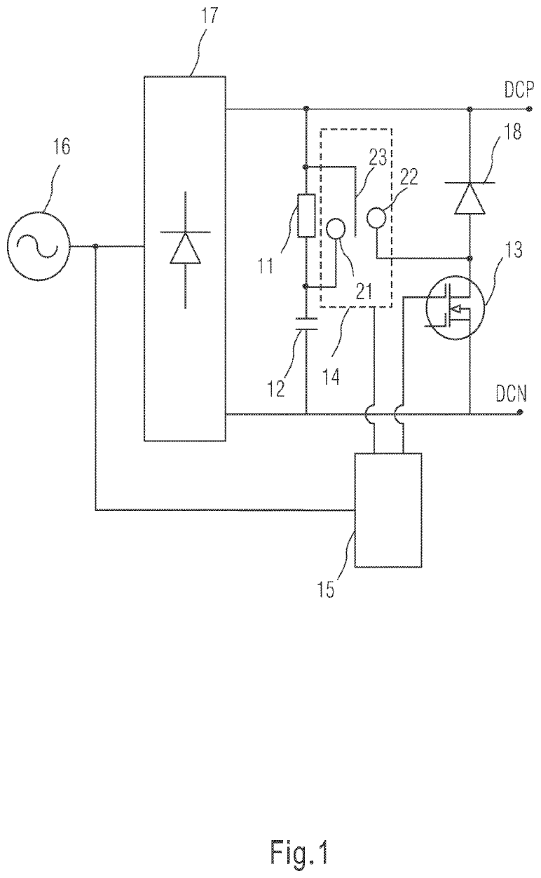

FIG. 1 is a structural diagram of an example discharging device for a DC bus capacitor of a converter incorporating teachings of the present disclosure. The device comprises: a resistor 11 is connected in series with DC bus capacitor 12 of converter; a braking IGBT13, connected between a positive electrode (DCP) and a negative electrode (DCN) of the DC bus capacitor12; a switch 14 which is connected with braking IGBT13 and resistor 11 respectively; and a control unit 15 configured to turn on the braking IGBT13 when power supply system 16 of the converter is detected to be powered off, and control the state of the switch 14 to turn on a discharging circuit of the DC bus capacitor 12, which comprises the resistor 11 and the braking IGBT13.

The resistor 11 include an in-surge resistor to suppress the charging surge current.

The converter comprises a rectifier module 17 (such as an AC/DC converter), a DC bus capacitor 12, and an inverter module (not shown in FIG. 1). The inverter module can be implemented as a DC/AC converter. Rectifier module 17 converts alternating current provided by power supply system 16 into direct current; The DC bus capacitor 12 filters the DC current provided by the rectifier module 17; The inverter module converts the filtered DC power into AC power for driving a motor (not shown in FIG. 1).

The switch 14 is an electronic element that interrupts current or causes it to flow to other circuits. The switch 14 may include one or more electronic contacts. When the switch 14 is closed, it indicates that the electronic contact is on, allowing the current to flow through the switch 14, also known as the “ON state” of the switch; Open means that the electronic contact is not conductive to form an open circuit, and the current is not allowed to flow through the switch 14, which is also called the “OFF state” of the switch. Specifically, the switch 14 may be implemented as a solid-state switch or an electromagnetic relay, and the like.

In some embodiments, the switch 14 comprises a SPDT switch. The SPDT switch comprises a first static contact 21, a second static contact 22 and a moving contact 23. The first static contact 21 is connected between a first end of the resistor 11 and the DC bus capacitor 12, the second static contact 22 is connected with the braking IGBT13, and the moving contact 23 is connected with a second end of the resistor 11.

The switch 14 is described above with SPDT switch as an example. Those skilled in the art can realize that this description is only exemplary and is not used to limit the protection scope of the present disclosure.

The converter also comprises braking IGBT13. Braking IGBT13 is used to discharge feedback energy provided by motor connected to the converter when the converter is working normally. For example, the braking IGBT13 comprising a grid, a collector, and an emitter, wherein the grid is connected with the control unit 15, the collector is connected with the DCP of the DC bus capacitor 12 through diode 18, and the emitter is connected with the DCN of the DC bus capacitor 12. The channel is formed by adding forward gate voltage to provide base current for PNP transistor, so that IGBT13 can be turned on. On the contrary, apply the reverse grid voltage to eliminate the channel, cut off the base current, and turn off IGBT13.

The above describes the switch 14 and the braking IGBT respectively with the SPDT switch and the specific IGBT structure as examples. Those skilled in the art can realize that this description is only exemplary and is not used to limit the protection scope of the present disclosure.

When control unit 15 detects that power supply system 16 is cut off, control unit 15 introduces braking IGBT13 into discharging circuit of the DC bus capacitor 12, thus reusing the braking IGBT13 to realize a rapid discharge of the DC bus capacitor and thereby reducing discharge time.

In some embodiments, the control unit 15 is configured to turn off the braking IGBT13 when detecting that the DC bus capacitor 12 is in charging state, and control the state of the switch 14 to conduct charging circuit of the DC bus capacitor 12. The charging circuit comprises a resistor 11 and a rectifier module 17 of the converter. Therefore, when it is detected that DC bus capacitor 12 is in charging state, turn off the braking IGBT13, and introduce resistor 11 in series with the DC bus capacitor 12 into charging circuit. The resistor 11 can limit instantaneous charging current at the moment of power on, thus protecting components such as the rectifier module 16.

In some embodiments, the control unit 15 is configured to control state of switch 14 to short circuit resistor 11 when detecting that DC bus capacitor 12 is in a power state. Therefore, when converter works normally, the resistor 11 is shorted to save energy.

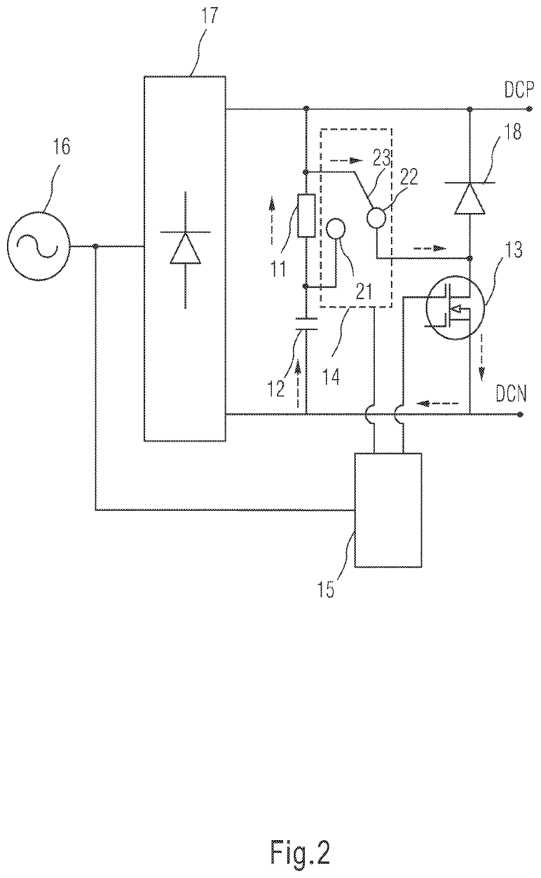

FIG. 2 is a schematic diagram of a discharging state of an example DC bus capacitor incorporating teachings of the present disclosure. In FIG. 2, when control unit 15 detects that the power supply system 16 of the converter is powered off, the control unit 15 turns on the braking IGBT 13, and controls the moving contact 23 of the switch 14 to make electrical contact with the second static contact 22. In the directions indicated by the arrows, the electricity released by the DC bus capacitor 12 flows through the resistor 11 and the control switch 14 (the moving contact 23 is in electrical contact with the second static contact 22), reaches brake IGBT 13 in conduction state, and returns to the DCN of the DC bus capacitor 12 to form a discharging circuit. Both resistor 11 and braking IGBT 13 are introduced into the discharging circuit of DC bus capacitor 12 to realize rapid discharge of DC bus capacitor 12 and thus reduce discharge time.

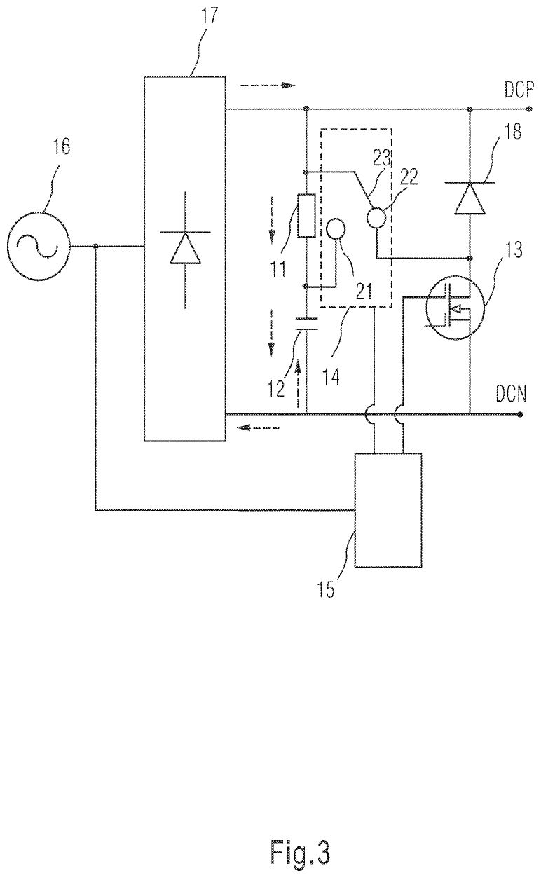

FIG. 3 is a schematic diagram of the charging state of an example DC bus capacitor incorporating teachings of the present disclosure. In FIG. 3, when the control unit 15 detects that DC bus capacitor 12 is in charging state (at this time, the rectifier module 17 charges DC bus capacitor 12), turn off the braking IGBT13. The control unit 15 also controls moving contact 23 of the switch 14 to electrically contact the second static contact 22. In the directions indicated by the arrows, the electricity supplied by rectifier module 17 passes through resistor 11 and DC bus capacitor 12 in turn and then returns to rectifier module 17 to form a charging circuit. Braking IGBT 13 has been closed, so braking IGBT 13 is not comprised in the charging circuit. The resistor 11 is introduced into the charging circuit of the DC bus capacitor. The resistor 11 can limit instantaneous charging current, thus protecting components such as rectifier modules.

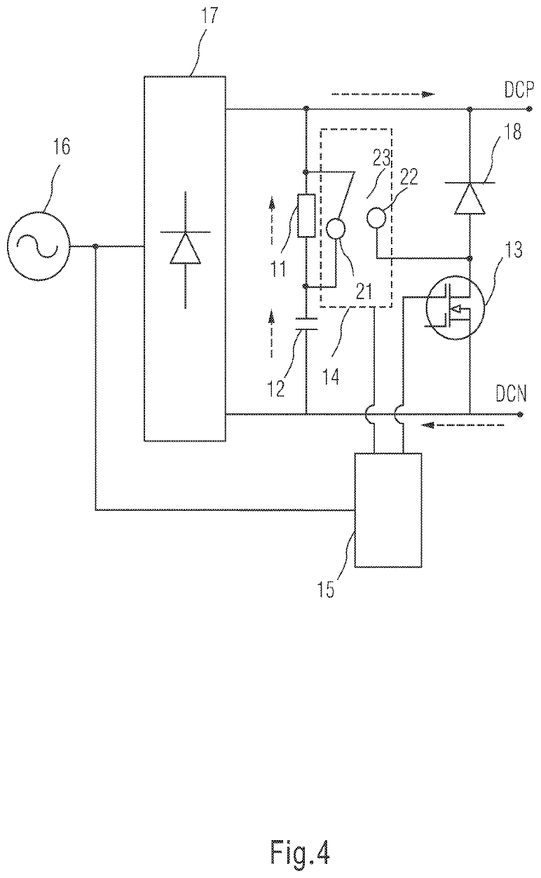

FIG. 4 is a schematic diagram of a normal working state of an example converter incorporating teachings of the present disclosure. In FIG. 4, when the control unit 15 detects that the DC bus capacitor 12 is in a normal working state (that is, providing electrical energy for motor), the moving contact 23 of the control switch 14 contacts the first static contact 21, thus shorting the resistor 11. When the converter is in normal working condition, braking IGBT13 is used to discharge feedback energy provided by motor connected to the converter. The opening or closing of braking IGBT13 can be determined based on the known mature logic. In the directions indicated by the arrows, the DC bus capacitor 12 can supply electricity to both ends of the DC bus for normal power supply of the motor through the path provided by the switch 14 (the moving contact 23 is in electrical contact with the first static contact 21). Furthermore, the resistor 11 is shorted, thereby saving energy.

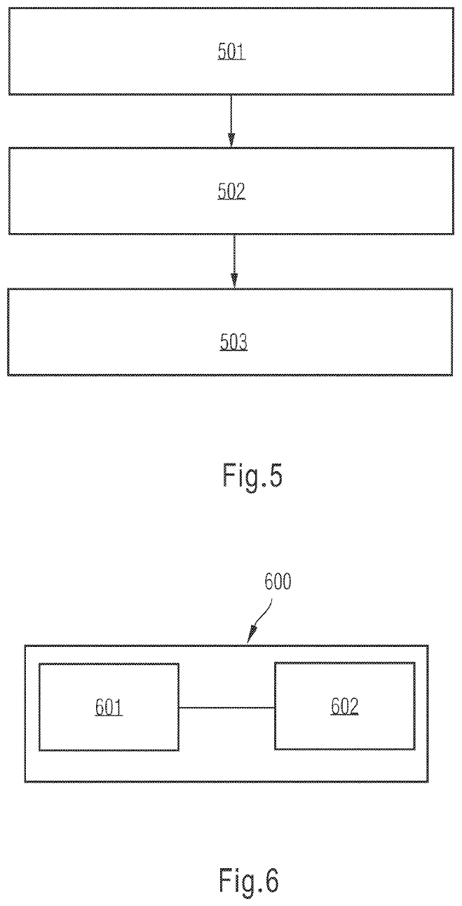

Some embodiments include a discharge method for a DC bus capacitor of a converter. FIG. 5 is a flowchart of an example discharging method for a DC bus capacitor of a converter incorporating teachings of the present disclosure. The converter comprises: a resistor which is connected in series with DC bus capacitor of the converter; a braking IGBT is connected between DCP and DCN of DC bus capacitor; a switch, connected with braking IGBT and resistor respectively.

As shown in FIG. 5, the method comprises:

Step 501: Detect an electrical connection state between the converter and the power supply system of the converter.

Step 502: When the electrical connection state indicates that the power supply system is powered off, turn on the braking IGBT.

Step 503: Control the state of the switch to conduct discharging circuit of the DC bus capacitor, and the discharging circuit comprising the resistor and braking IGBT.

In some embodiments, the method further comprises: turning off the braking IGBT when detecting that the DC bus capacitor is in a charging state; and controlling a state of the switch to conduct a charging circuit of the DC bus capacitor, the charging circuit comprising the resistor and a rectifier module of the converter.

In some embodiments, the method further comprises controlling a state of the switch to short-circuit the resistor when detecting that the converter is in a normal working state.

In some embodiments, the switch comprises a single pole double throw switch, the single pole double throw switch comprising a first static contact, a second static contact and a moving contact, the first static contact is connected between a first terminal of the resistor and the DC bus capacitor, the second static contact is connected with the braking IGBT, and the moving contact is connected with a second terminal of the resistor, wherein the controlling the state of the switch to conduct the discharging circuit of the DC bus capacitor comprising: controlling the moving contact to be in electrical contact with the second static contact, wherein the controlling a state of the switch to conduct a charging circuit of the DC bus capacitor comprising: controlling the moving contact to be in electrical contact with the second static contact, wherein the controlling a state of the switch to short-circuit the resistor comprising: controlling the moving contact to be in electrical contact with the first static contact.

Some embodiments include an electrical device with a processor memory architecture. FIG. 6 is a structural diagram of an example electrical device incorporating teachings of the present disclosure. As shown in FIG. 6, the electrical equipment 600 includes a processor 601, a memory 602, and a computer program stored on the memory 602 and capable of running on the processor 601. When the computer program is executed by the processor 601, one or more of the methods for discharging a DC bus capacitor of a converter as described herein is realized. Among them, the memory 602 can be specifically implemented as EEPROM, Flash memory, PROM and other storage media. The processor 601 may be implemented to include one or more central processors or one or more field programmable gate arrays, wherein the field programmable gate arrays integrate one or more central processor cores. Specifically, the central processor or central processor core can be implemented as a CPU or MCU or DSP, and so on.

Not all steps and modules in the above processes and structure diagrams are necessary, and some steps or modules can be ignored according to actual needs. The execution sequence of each step is not fixed and can be adjusted as required. The division of each module is only for the convenience of describing the functional division adopted. In actual implementation, a module can be divided into multiple modules, and the functions of multiple modules can also be realized by the same module. These modules can be in the same device or in different devices.

The hardware modules in each embodiment may be implemented mechanically or electronically. For example, a hardware module can include a specially designed permanent circuit or logic device (such as a special processor, such as FPGA or ASIC) to complete a specific operation. Hardware modules may also include programmable logic devices or circuits temporarily configured by software, such as including general-purpose processors or other programmable processors, for performing specific operations. As for the specific implementation of hardware modules by mechanical means, or by special permanent circuits, or by temporarily configured circuits (such as those configured by software), it can be determined according to the consideration of cost and time.

The above is only a description of example embodiments of the teachings herein and is not intended to limit the scope of protection of the present disclosure. Any modification, equivalent replacement, improvement, etc. made within the spirit and principle of the disclosure shall be included in the protection scope thereof.

What is claimed is:

1. A discharge device for a DC bus capacitor, the device comprising:
a resistor connected in series with a DC bus capacitor of a converter;
a braking IGBT connected between a positive electrode and a negative electrode of the DC bus capacitor
a switch connected to the braking IGBT and the resistor; and
a control unit to turn on the braking IGBT in response to a power supply system of the converter being powered off, and control a state of the switch to discharge the DC bus capacitor, using the resistor and the braking IGBT.

2. The device according to claim 1, wherein:
the control unit turns off the braking IGBT if the DC bus capacitor is in a charging state, and control a state of the switch to connect a charging circuit of the DC bus capacitor;
the charging circuit comprising the resistor and a rectifier module of the converter.

3. The device according to claim 1, wherein the control unit controls a state of the switch to short-circuit the resistor if the converter is in a normal working state.

4. The device according to claim 1, wherein:
the switch includes a single pole double throw switch comprising a first static contact, a second static contact, and a moving contact;
the first static contact is connected between a first terminal of the resistor and the DC bus capacitor;
the second static contact is connected to the braking IGBT; and
the moving contact is connected to a second terminal of the resistor.

5. The device according to claim 1, wherein:
the braking IGBT includes: a grid, a collector, and an emitter;
the grid is connected to the control unit;
the collector is connected to a positive electrode of the DC bus capacitor via a diode; and
the emitter is connected to a negative electrode of the DC bus capacitor.

6. A method for discharging a DC bus capacitor of a converter, the converter including: a resistor connected in series with a DC bus capacitor of the converter, a braking IGBT connected between a positive electrode and a negative electrode of the DC bus capacitor, and a switch connected to the braking IGBT and the resistor, the method comprising:
detecting an electrical connection state between the converter and a power supply system of the converter;
turning on the braking IGBT when the electrical connection state indicates that the power supply system is powered off;
controlling a state of the switch to conduct a discharging circuit of the DC bus capacitor, the discharging circuit comprising the resistor and the braking IGBT.

7. The method according to claim 6, further comprising:
turning off the braking IGBT when detecting that the DC bus capacitor is in a charging state; and
controlling a state of the switch to conduct a charging circuit of the DC bus capacitor, the charging circuit comprising the resistor and a rectifier module of the converter.

8. The method according to claim 6, further comprising
controlling a state of the switch to short-circuit the resistor when detecting that the converter is in a normal working state.

9. The method according to claim 6, wherein:
the switch comprises a single pole double throw switch comprising a first static contact, a second static contact, and a moving contact;
the first static contact is connected between a first terminal of the resistor and the DC bus capacitor; the second static contact is connected with the braking IGBT; and
the moving contact is connected with a second terminal of the resistor;
wherein the controlling the state of the switch to conduct the discharging circuit of the DC bus capacitor comprises controlling the moving contact to be in electrical contact with the second static contact.

10. The method according to claim 7, wherein:
the switch comprises a single pole double throw switch with a first static contact, a second static contact and a moving contact;
the first static contact is connected between a first terminal of the resistor and the DC bus capacitor;
the second static contact is connected with the braking IGBT; and
the moving contact is connected with a second terminal of the resistor;
wherein controlling a state of the switch to conduct a charging circuit of the DC bus capacitor comprises controlling the moving contact to be in electrical contact with the second static contact.

11. The method according to claim 8, wherein:
the switch includes a single pole double throw switch comprising a first static contact, a second static contact and a moving contact;
the first static contact is connected between a first terminal of the resistor and the DC bus capacitor;
the second static contact is connected with the braking IGBT; and
the moving contact is connected with a second terminal of the resistor;
wherein controlling a state of the switch to short-circuit the resistor comprises controlling the moving contact to be in electrical contact with the first static contact.

12-14. (canceled)
